(19) United States
(12) Patent Application Publication
(10) Pub. No.: US 2007/0051135 A1
(43) Pub. Date: Mar. 8, 2007

(54) Method for manufacturing porous-glass material for optical fiber, and glass base material

(75) Inventors: Hiroshi Machida, Ibaraki (JP); Mitsuji Sato, Ibaraki (JP)

Correspondence Address: MCGINN INTELLECTUAL PROPERTY LAW GROUP, PLLC, 8321 OLD COURTHOUSE ROAD, SUITE 200, VIENNA, VA, 22182-3817, US

(73) Assignee: SHIN-ETSU CHEMICAL CO., LTD., Tokyo (JP)

(21) Appl. No.: 11/513,103

(22) Filed: Aug. 31, 2006

Related U.S. Application Data
(63) Continuation-in-part of application No. PCT/JP05/00258, filed on Jan. 12, 2005.

(30) Foreign Application Priority Data
Mar. 3, 2004 (JP) JP 2004-059207

(51) Int. Cl. C03C 3/06; C03B 37/07; C03B 37/018; G01N 21/00

(52) U.S. Cl. 65/377; 65/379; 65/421; 501/54

(57) ABSTRACT

A method for manufacturing a porous-glass material for optical fiber performed in a reaction apparatus having a plurality of burners for producing glass particles toward a initial base material and a ventilation mechanism at a position opposed to the plurality of burners, the method comprises the steps of (a) moving the plurality of burners back and forth along a initial base material, (b) depositing the glass particles produced by the flame hydrolysis reaction of the glass raw material around the initial base material, (c) starting the deposition of a next porous-glass material without removing soot stuck to the inside of the chamber after the deposition of the glass particles is completed. Under the above condition, the inside pressure of the chamber is preferably adjusted within the range of −80 Pa≦Pₘᵢₙ≦−40 Pa, which is a pressure differential between the inside and outside of the chamber. (Hereinafter referred to a pressure differential between the inside and outside of the apparatus)

### CROSS REFERENCE TO RELATED APPLICATION

This patent application is a CIP application of PCT/JP05/000258 filed on Jan. 12, 2005, which claims priority from a Japanese patent application No. 2004-059207 filed on Mar. 3, 2004, the contents of which are incorporated herein by reference.

### BACKGROUND

1. Field of the Invention

The present invention relates to a method for manufacturing a porous-glass material for optical fiber, and a glass base material. More particularly, the present invention relates to a method for manufacturing a porous-glass material for optical fiber, and a glass base material, in which the productivity of the porous-glass material is improved due to less labor or the like in an outside vapor deposition method, and a quality of a glass base material is provided by reducing a formation of air bubbles in the glass base material.

2. Description of the Related Art

With recent downturn in the optical fiber industry, a productivity improvement are further required as well as a quality improvement in a process for manufacturing a silica glass base material for optical fiber. Especially, in terms of the productivity improvement, contrary to a strong desire for a pursuit of speeding up production in order to achieve mass production as in old times, less labor caused by a process rationalization, a process improvement or the like has been required in order to reduce a manufacturing cost.

Generally, in a method for manufacturing a porous-glass material for optical fiber, a porous-glass material is manufactured in a reaction apparatus by means of an Outer Vapor-phase Deposition method (OVD method) in such a manner that glass particles produced by the flame hydrolysis reaction of a glass raw material are deposited around a large part of the peripheral surface of an axially rotated target rod (a initial base material). Then, the porous-glass material manufactured by the Outer Vapor-phase Deposition method is dehydrated, sintered, and vitrified in a verification apparatus, which is different from the above reaction apparatus in order to obtain a glass base material.

The porous-glass material obtained by depositing a certain amount of the glass particles around the peripheral surface of the target rod is taken out from the reaction apparatus. Subsequently, as a process of next batch, the glass particles are deposited around the peripheral surface of a next target rod in order to obtain a next porous-glass material. As shown in FIG. 1, however, there is a plurality of working process between two batches

In a process for manufacturing a porous-glass material by means of the OVD method, a large amount of SiO₂ particles (soot) generated by burners are stuck to the peripheral surface of the target rod. Herein, soot might be stuck to the peripheral surface of the target rod due the reason of chemical reaction and particle growth of soot in flame burners, in addition, thermal migration of soot around a soot-deposited surface. In this moment, all of the above glass soot is not stuck to the soot-deposited surface. Thus, soot, which was not deposited around the soot-deposited surface, is inevitably suspended in a chamber. Most of such soot (hereinafter refers to “non-stuck soot”) is discharged to outside of the chamber by means of an exhaust system provided in the reaction apparatus. However, non-stuck soot, which was not discharged to outside of the chamber, is suspended in the inside of chamber. Consequently, such non-stuck soot is stuck to an inner wall of the chamber to form a layer of a soot-deposition.

A process of “REMOVING SOOT STUCK TO INSIDE OF CHAMBER” shown in FIG. 1 is executed by means of a sweeper to vacuum soot, which were stuck to an inner wall of the chamber. This process is executed before a process of a next batch is started, namely, the soot are deposited around a next target rod. This process is indispensable due to the following reason. Usually, the soot stuck to the inner wall of chamber as the layer of the soot-deposition is peeled off, fallen into and stuck to the soot-deposited surface of the next target rod during the process of manufacturing the porous-glass material. As a result, when the porous-glass material manufactured by the above condition is vitrified in the verification apparatus, air bubbles are formed on the glass base material.

Some method can be exemplified for preventing non-stuck soot from being stuck to the inner wall of chamber. For example, firstly, in order to increase amount of soot discharged from an exhaust system, a method of applying a large amount of negative pressure to the chamber is available. Secondly, in order to decrease amount of non-stuck soot suspended in the chamber, a method of enhancing soot deposition efficiency is available.

Especially, the latter case is disclosed in the cited reference 1 (Japanese Patent Publication 2001-278634). This method is to adjust the inside pressure P of the chamber within the range of 0 Pa>P>−30 Pa in order to enhance soot deposition efficiency. Additionally, the latter case is also disclosed in the cited reference 2 (Japanese Patent Publication 2003-073138). This method is to adjust the inside pressure P of the chamber within the range of 0 Pa>P>−15 Pa when soot start sticking to the inside wall of the chamber, subsequently, to adjust the inside pressure P of the chamber to −30 Pa as a process of depositing soot around the target rod is proceeding. Due to this method, air bubbles can be prevented from being formed in the glass base material.

However, when a soot deposition is executed by the above method disclosed in both cited references 1 and 2, the following drawbacks could be realized.

A high quality of porous-glass material can be obtained by the manufacturing process of a single batch under the condition that the inside pressure P of the chamber is adjusted to −30 Pa. In manufacturing a next porous-glass material, however, if the conventional indispensable process of “REMOVING SOOT STUCK TO INSIDE OF CHAMBER” shown in FIG. 1 is omitted in order to reduce the manufacturing cost, the number of air bubbles on the glass base material is increased as the number of the batch is increased, namely, the number of depositing soot around the target rod is increased.

### SUMMARY

Therefore, an aspect of the present invention is to provide a method for manufacturing a porous-glass material for optical fiber, and a glass base material, in which the cost of a product is reduced by omitting a working process between batches without exerting an adverse influence on the quality of the porous-glass material and the glass base material.

According to a method for manufacturing a porous-glass material for optical fiber of an embodiment of the present invention performed in a reaction apparatus having burners for producing glass particles toward a initial base material and a ventilation mechanism at a position opposed to the burners, the method comprises the steps of (a) moving the burners back and forth along the initial base material, (b) depositing the glass particles produced by the flame hydrolysis reaction of the glass raw material around the initial base material, (c) starting the deposition of a next porous-glass material without removing soot stuck to the inside of the chamber after the deposition of the glass particles is completed. Under the above condition, the inside pressure of the chamber is preferably adjusted within the range of −80 Pa≦Pₘᵢₙ≦−40 Pa, which is a pressure differential between the inside and outside of the chamber. (Hereinafter referred to a pressure differential between the inside and outside of the apparatus)

The summary clause does not necessarily describe all necessary features of the present invention. The present invention may also be a sub-combination of the features described above.

According to the above method according to the embodiment of the present invention, the inside pressure of the chamber is adjusted so as to set the pressure differential between the inside and outside of the apparatus within the range of −80 Pa≦Pₘᵢₙ≦−40 Pa. Thus, even though a process for manufacturing the porous-glass material dose not include the conventional indispensable working process between batches for removing soot stuck to the inner wall of the chamber after a porous-glass material is taken out from the apparatus, it is possible to provide a glass base material for optical fiber with an excellent optical characteristic and almost free from air bubbles at its inside by which the cost of a product is reduced without exerting an adverse influence on the quality

### BRIEF DESCRIPTION OF THE DRAWINGS

FIG. 1 is an explanation view showing an example of a working process between batches in the OVD method.

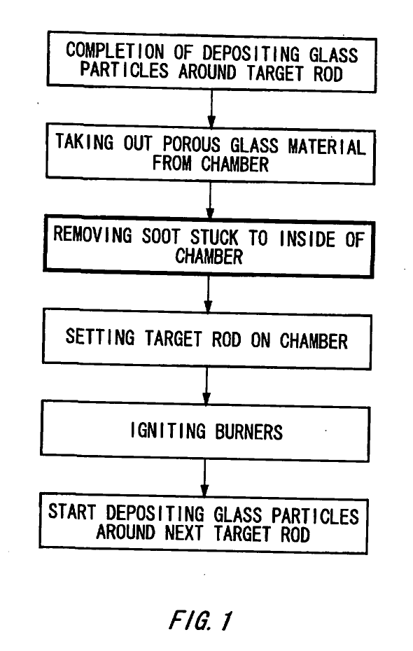

FIG. 2 A is a front explanation view showing an example of an apparatus for manufacturing a porous-glass material by the OVD method, and FIG. 2B is a side explanation view showing the apparatus shown in FIG. 2A.

FIG. 3 shows a graph indicating a relation ship between the number of depositing glass particles around a target rod and the number of formation of air bubbles on one glass base material in Example 1.

FIG. 4 shows a graph indicating a relation ship between the number of depositing glass particles around a target rod and the number of formation of air bubbles on one glass base material in Comparative Examples 1 and 2.

FIG. 5 shows a graph indicating a relation ship between the number of depositing glass particles around a target rod and the number of formation of air bubbles on one glass base material in Comparative Examples 1 to 3.

### EXEMPLARY EMBODIMENTS

Some embodiments of the invention will now be described based on the preferred embodiments, which do not intend to limit the scope of the present invention, but exemplify the invention. All of the features and the combinations thereof described in the embodiment are not necessarily essential to the invention.

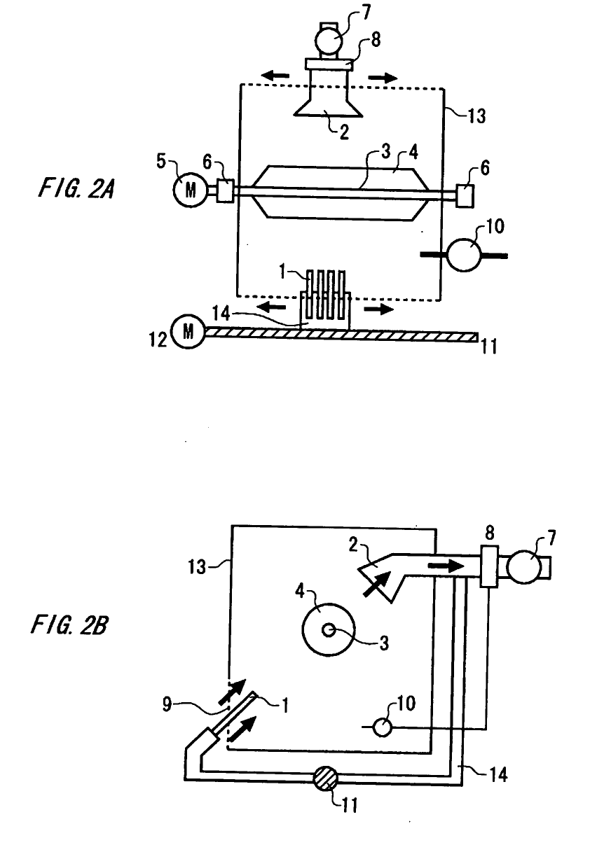

A method for manufacturing a porous-glass material 4 for optical fiber of the present embodiment will now be described by referring to FIGS. 2A and 2B showing an example of a apparatus. As shown in FIG. 2A, there is provided burners 1 and a ventilation duct 2 for sweeping out of vacuuming off soot (a ventilation mechanism) in a chamber 13 of the apparatus. The ventilation duct 2 is located at a position opposed to the burners 1. Additionally, a target rod 3 (or an initial base material) is held by means of a chucking jig 6 equipping with a rotary motor 5. The burners 1 are provided on the apparatus so that the burners 1 are relatively movable back and forth with respect to the target rod 3 along an axis 11 and a lateral motion-motor 12 provided under a bottom the chamber 13. The ventilation duct 2 is provided on the apparatus so that the ventilation duct 2 is movable in accordance or together with the reciprocal movement of the burners 1. In this case, as shown in FIG. 2B, the burners 1 and the ventilation duct 2 are linked to each other by a link frame 14.

In another embodiment (not shown), the burners 1 may not be linked to the ventilation duct 2 but driven to reciprocate along an axis by a respective motor. Further, in still another embodiment (not shown), the target rod 3 moves while both the burners 1 and the ventilation duct 2 are secured to the apparatus.

The glass particles or soot generated by means of the flame hydrolysis reaction of the glass raw material in the oxyhydrogen flame are deposited around the axially rotating target rod 3. After a certain amount of soot is deposited and the porous-glass material 4 is produced, the porous-glass material 4 is taken out of the apparatus.

After that, soot in the next batch starts to deposit around the next target without the intricate process of removing soot stuck to an inner wall of a chamber before the next batch is started.

In the process of the deposition of the porous-glass material, a pressure differential between the inside and outside of the apparatus is adjusted within a range of −80 Pa≦Pₘᵢₙ≦−40 Pa. Under the above condition, the cost of manufacturing products can be reduced without exerting an adverse affect on the products or the glass base material 4.

Now, the followings are explanations regarding to the method for adjusting the inside pressure of the chamber within the range of −80 Pa≦Pₘᵢₙ≦−40 Pa and the method for discharging the non-stuck soot floating within the chamber 13 to outside of the chamber 13 through the ventilation duct 2.

Both of these methods will now be described by referring to FIGS. 2A and 2B. As shown in FIG. 2B, the inside of the chamber 13 is kept under a negative pressure within the range of −80 Pa≦Pₘᵢₙ≦−40 Pa by vacuuming air by means of a negative pressure fan 7. Here, the pressure difference may be manually or automatically adjusted by means of a pressure regulating valve 8 connecting to a pressure gauge 10. Fresh air flows into the chamber 13 through a filter 9. Then, such fresh air is discharged to the outside of the chamber 13 via the ventilation duct 2 by the negative pressure fan 7. By appropriately controlling the pressure regulating valve 8 in response to the pressure measurement by the pressure gauge 10, negative pressure in the chamber 13 can be maintained in the range of −80 Pa≦Pₘᵢₙ≦−40 Pa.

When air flowing into the chamber 13 through the filter 9 and air discharging out through the duct 2 is stabilized while the negative pressure in the chamber 13 is maintained in the range of −80 Pa≦Pₘᵢₙ≦−40 Pa, all soot is vacuumed out carrying on the circulation of air flow. As a result, such soot can be effectively removed out of the chamber 13.

Now, the importance of adjusting the pressure differential between the inside and outside of the chamber within the range of −80 Pa≦Pₘᵢₙ≦−40 Pa will be described below. When the pressure differential between the inside and outside of the apparatus is larger than Pₘᵢₙ=−40 Pa, the number of air bubbles formed in the glass base material is increased as the number of depositing glass particles around the target rod is increased. This is because as the number of depositing glass particles around the target rod 3 is increased, amount of soot stuck to an inner wall of the chamber is increased. Then, a part of soot stuck to the inner wall of the chamber is peeled off, fallen into and stuck to the soot-deposited surface of the next target rod immediately after such soot is peeled off or when such soot is left inside the chamber 13.

On the other hand, when the pressure inside and outside of the apparatus is lower than Pₘᵢₙ=−80 Pa, atmospheric pressure is easily comes into the chamber 13 due to a large amount of pressure difference. Accordingly, a sufficient air tightness of the apparatus must be ensured. Otherwise, the number of air bubbles formed in the porous-glass material increases as the number of depositing glass particles around the target rod 3 increases.

Specifically, the apparatus by the use of the OVD method includes a portion for taking out the porous-glass material, an opening part for maintenance, a window for observation or the like. These portions need to be constituted by a seal structure capable of imparting air tightness to the chamber. Thus, if the pressure differential between the inside and outside of the apparatus is smaller than Pₘᵢₙ=−80 Pa, a large amount of cost is required in order to ensure air tightness of the apparatus. As a result, the cost of manufacturing products cannot be reduced.

Accordingly, as long as the pressure differential between the inside and outside of the apparatus is larger than Pₘᵢₙ=−80 Pa, there is less possibility that air bubble is formed in the glass base material even though the atmosphere pressure is flowed into the apparatus. This is because as long as the above pressure range is maintained, a leaking amount of the atmosphere air is small even in the case that the above portions are sealed in usual processes.

As described above, it is important for the method of manufacturing the porous-glass material of the present embodiment to adjust the pressure differential Pₘᵢₙ inside the apparatus within the above mentioned range.

### EXEMPLARY EMBODIMENT

### Example 1

A porous-glass material was manufactured by the use of a apparatus as shown in FIGS. 2A and 2B. A target rod made of silica glass having a length of 50 mm is set in the apparatus, and then glass shoots are deposited around the peripheral surface of a target rod by the use of a concentric multiple pipes-burners in an OVD method. Herein, the burner used in the apparatus has a concentric quintuple pipe structure, and there is provided four of the above burners in the apparatus in such a manner that each burner is placed 150 mm apart. In supplying gas to burners, the gas blowing flow rate of source gas, oxygen and hydrogen were adjusted to the following condition, respectively, in accordance with the increase of diameter caused by depositing the soot around the target rod. At the beginning of the deposition of soot, 1 Nl/min/burner of source gas (SiCl₄) and 8 Nl/min/burner of oxygen are supplied to a center pipe. 50 Nl/min/burner of hydrogen is supplied to a third pipe. 20 Nl/min/burner of oxygen is supplied to a fifth pipe. At the end of the deposition of glass soot, 10 Nl/min/burner of source gas (SiCl₄) and 20 Nl/min/burner of oxygen are supplied to a center pipe. 200 Nl/min/burner of hydrogen is supplied to a third pipe. 4 Nl/min/burner of Nitrogen is supplied to a fourth pipe. 60 Nl/min/burner of oxygen is supplied to a fifth pipe. Under the above condition, the soot is deposited around the peripheral surface of the target rod during the period of 50 hours in order to obtain 100 kg of the porous-glass material.

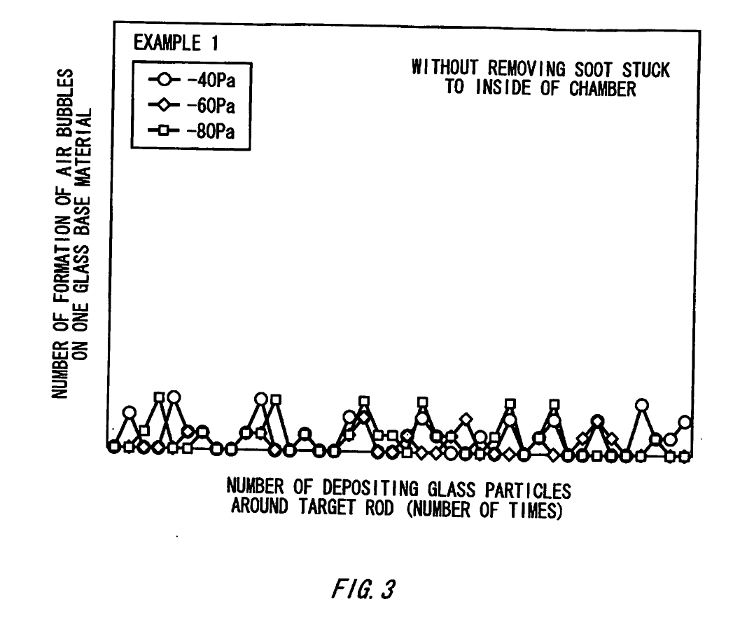

The above porous-glass materials were repeatedly manufactured by the use of the first apparatus, the second apparatus and the third apparatus, respectively, under the condition that the pressure differential Pₘᵢₙ between the inside and outside of the first apparatus, the second apparatus and the third apparatus were adjusted to −40 Pa, −60 Pa, and −80 Pa. As a result shown in the graph of FIG. 3, under all of the pressures of −40 Pa, −60 Pa, and −80 Pa, the number of formation of air bubbles was not increased in the glass base material even though the number of depositing glass particles around a target rod is increased.

### Comparative Example 1

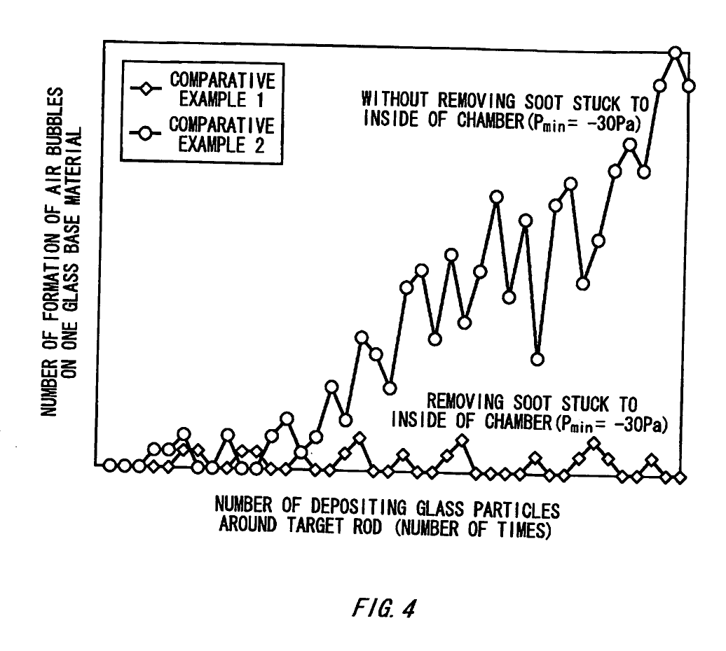

A porous-glass material was manufactured by the use of the apparatus as shown in FIG. 2. A target rod made of silica glass having a length of 50 mm is set in the apparatus, and then glass shoots are deposited around the peripheral surface of a target rod by the use of a concentric multiple pipes-burners in an OVD method. Herein, the burner used in the apparatus has a concentric quintuple pipe structure, and there is provided four such burners in the apparatus in such a manner that each burner is placed 150 mm apart. In supplying gas to burners, the gas blowing flow rate of source gas, oxygen and hydrogen were adjusted to the same value as that of Example 1. Under the above condition, glass shoots are deposited around the peripheral surface of the target rod during the period of 50 hours in order to obtain 100 kg of the porous-glass material. The above porous-glass materials were repeatedly manufactured under the condition that the pressure differential Pₘᵢₙ between the inside and outside of the apparatus was adjusted to −30 Pa. In the above method for manufacturing the porous-glass material, however, after one porous-glass material was manufactured, soot stuck to an inner wall of a chamber was removed by means of a sweeper before staring a deposition of soot around a next target rod. A result is shown in the graph of FIG. 4 indicating a relation ship between the number of formation of air bubbles on one glass base material and the number of depositing glass particles around a target rod. As clearly shown in FIG. 4, as long as glass soot stuck to an inner wall of the chamber is removed before starting a deposition of glass soot around a next target rod, the number of formation of air bubbles is not increased in the glass base material even though the number of depositing glass particles around a target rod is increased under the condition that the pressure differential Pₘᵢₙ between the inside and outside of the apparatus was adjusted to −30 Pa. However, a working process for removing glass soot stuck to the chamber between the batches was extremely a hard work.

### Comparative Example 2

Porous-glass materials were repeatedly manufactured by the same condition as that of Example 1 except for the following conditions. The pressure differential Pₘᵢₙ between the inside and outside of the apparatus was adjusted to −30 Pa during the course of deposition of glass soot. A deposition of glass soot around a next target rod is started without a process for removing soot stuck to the inner wall of the chamber. As a result clearly shown in the graph of FIG. 4, the number of formation of air bubbles was increased in the glass base material as the number of depositing glass particles around a target rod was increased.

### Comparative Example 3

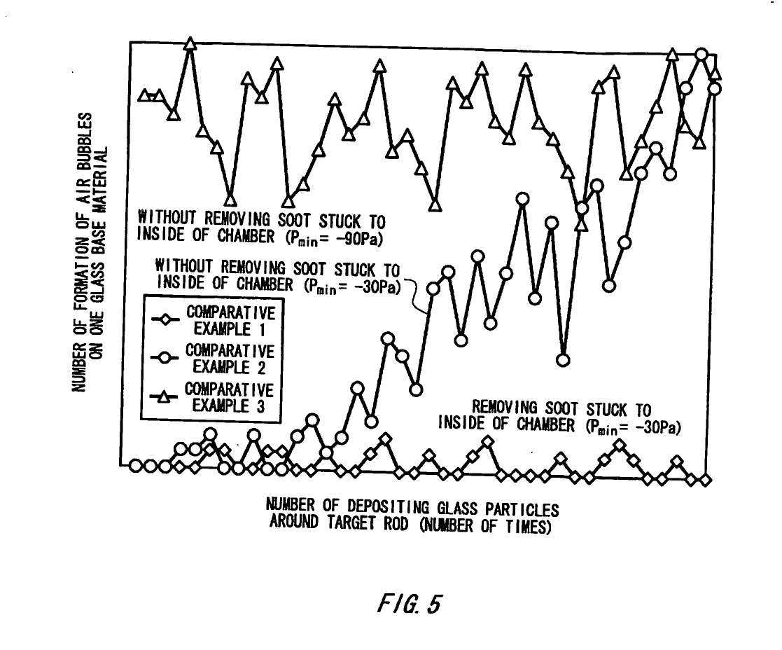

Porous-glass materials were repeatedly manufactured by the same condition as that of Example 1 except for the following conditions. The pressure differential Pₘᵢₙ between the inside and outside of the apparatus was adjusted to −90 Pa during the course of deposition of glass soot. A deposition of glass soot around a next target rod is started without a process for removing glass soot stuck to the inner wall of the chamber. As a result clearly shown in the graph of FIG. 5, the number of formation of air bubble was extremely increased in the glass base material regardless of the number of depositing glass particles around a target rod.

Although some embodiments of the present invention has been described by way of exemplary embodiments, it should be understood that those skilled in the art might make many changes and substitutions without departing from the spirit and the scope of the present invention, which is defined only by the appended claims.

What is claimed is:

1. A method for manufacturing a porous-glass material for optical fiber performed in a reaction apparatus having a plurality of burners for producing glass particles toward a initial base material and a ventilation mechanism at a position opposed to the plurality of burners, the method comprising the steps of:
(a) moving the plurality of burners back and forth along a initial base material;
(b) depositing the glass particles produced by the flame hydrolysis reaction of the glass raw material around the initial base material,
(c) starting the deposition of a next porous-glass material without removing soot stuck to the inside of the chamber after the deposition of the glass particles is completed.

2. The method for manufacturing a porous-glass material for optical fiber as claimed in claim 1, wherein a pressure differential between the inside and outside of the apparatus is adjusted within the range of −80 Pa≦Pₘᵢₙ≦−40 Pa.

3. A method for manufacturing a porous-glass material for optical fiber performed in a reaction apparatus having a plurality of burners for producing glass particles toward a initial base material and a ventilation mechanism at a position opposed to the plurality of burners, the method comprising the steps of adjusting a pressure differential between the inside and outside of the apparatus within the range of −80 Pa≦Pₘᵢₙ≦−40 Pa.

4. A glass material for optical fiber obtained by dehydrating, sintering, and vitrifying a porous-glass material manufactured by the method as claimed in claim 1.

5. A glass material for optical fiber obtained by dehydrating, sintering, and vitrifying a porous-glass material manufactured by the method as claimed in claim 2.
